(19) United States
(12) Patent Application Publication
(10) Pub. No.: US 2015/0177461 A1
(43) Pub. Date: Jun. 25, 2015

(54) Explosion proof fusion splicer for optical fibers

(71) Applicants: Simon P. Bush, Ambler, PA (US); Nellie L. Cabato, Plymouth Meeting, PA (US); Joseph W. Jackson, JR., Wilmington, DE (US); Ian C. McDermott, Lincoln University, PA (US); Laurence N. Wesson, Blue Bell, PA (US)

(72) Inventors: Simon P. Bush, Ambler, PA (US); Nellie L. Cabato, Plymouth Meeting, PA (US); Joseph W. Jackson, JR., Wilmington, DE (US); Ian C. McDermott, Lincoln University, PA (US); Laurence N. Wesson, Blue Bell, PA (US)

(21) Appl. No.: 13/998,921

(22) Filed: Dec. 23, 2013

(51) Int. Cl. G02B 6/255

(52) U.S. Cl. CPC G02B 6/2553

(57) ABSTRACT

An explosion proof optical fiber splicer system includes a gasket sealed arc chamber fed with purging inert gas to exclude ambient air which may be contaminated with explosive hazardous gases or particles. Prepared bare fiber ends are placed within the chamber on a pedestal held by fiber clamps. An arc between electrodes perpendicular to the fiber line is made possible only when adequate inert gas is present as controlled by a control monitor. The control monitor receives information from sensors within the arc chamber regarding oxygen content, inert gas pressure, and flow volume. The explosion proof optical fiber splicer system is compact and can be used in contained narrow spaces without need for disassembly of optical connections.

### 1. FIELD OF THE INVENTION

The present invention relates to an explosion proof fusion splicing system for optical fiber. The system finds use in ambient conditions wherein explosive or hazardous gases are present or suspected to be present. Under such conditions an arc can initiate an explosion; this is especially the case in enclosed areas or restricted regions within equipment spaces found in airlines, ships, or advanced machinery that frequently use optical communication within devices.

### 2. DESCRIPTION OF THE PRIOR ART

Numerous prior art patents and disclosures relate to fusing of optical fibers. These techniques may be generally classed as arc fusion methods, incandescent heating methods, open flame, or laser heating fusion methods. Due to the small physical size of optical fibers and an even smaller central portion that delivers the optical signal, the optical fibers need to be aligned very carefully to create an optical fiber joint that has low loss. Generally, before fusion the fiber ends must be stripped of their protective polymeric coating, and they must be free from contamination such as dirt. The ends must be cut or “cleaved” precisely in such a way as to present a flat and featureless end surface as near as possible to perfectly perpendicular to the axis.

U.S. Pat. No. 4,274,707 to Pacey, et al. discloses an apparatus for fusion splicing of optical fibers. A pair of optical fibers is fused end-to-end by an electrical arc. The fusion apparatus has a fiber gripping head on a support housing within which the various electrical and electronic circuits and control devices are housed. The gripping head has two fiber holding members, each member having a first portion for holding a coated portion of a fiber and a second spring loaded portion adapted to bear on a stripped portion of a fiber end. The second portion is deflectable relative to the first portion. Two electrodes, in opposition, are mounted one on each side of an axis through the fiber ends. A prefusion arc can be provided for initial rounding of the fiber ends. The prefusion arc and fusion arc times can be preset. Transfer members can be mounted on the housing for moving a fused pair of fibers to a heating position where a heat shrink sleeve, previously slid on one of the fiber ends can be positioned over the splice and heat shrunk on to the splice. The two fibers are stripped of the plastic coating and are moved into the ‘vee’ grooves to bring the free ends of the fibers in very close proximity or butted against each other optionally with an applied loading to one of the fibers. The arc melts the free ends of the two fibers, which are pushed to form a fusion bond. The fusion process is not conducted in inert gas and the arc takes place in ambient air which may contain explosive and or hazardous gases and may result in an explosion.

U.S. Pat. No. 4,810,054 to Shinbori, et al. discloses a fusion splicing method for optical fibers. In this method optical fibers are fusion spliced in an inert gas atmosphere after water adsorbed on their surfaces is removed by decomposition in a plasma of an inert gas containing a halogen. The plasma is generated through a radio frequency glow discharge. The fusion splicing is carried out at the abutted ends of the optical fibers in an atmosphere of dry gas. The fusion splicing method is characterized in that impurities such as water adsorbed on the fiber surfaces near the butted portion of the fibers to be connected are removed through use of a plasma of an inert gas containing a halogen, after which their fusion splicing is performed by an arc discharge, or through use of infrared light such as CO₂ laser light, in an atmosphere of an inert gas such as argon, helium, or the like. By treating the fiber surfaces in a plasma containing a halogen, as mentioned above, the halogen in its nascent state reacts, at a range of low temperature, with impurities on the fiber surfaces and is decomposed into materials which have a small energy of adsorption on glass, such as hydrogen halide or oxygen; accordingly, adsorbed water and other impurities on the fiber surfaces can easily be removed at a range of low temperature, permitting the fusion splicing of fluoride glass fibers which has been difficult in conventional art. Moreover, high-strength fusion splicing of the quartz fibers also becomes possible. This method uses a vacuum pump to evacuate the chamber. Evacuation of the chamber is carried out prior to filling the chamber with an argon halogen low pressure gas mixture, and prior to applying a radio frequency glow discharge plasma. Application of the plasma strips away any surface adherent films on the ends of the optical fibers. The chamber is then filled with atmospheric pressure argon and an arc is struck between two electrodes positioned perpendicular to the line of optical fibers, softening or melting the tips of the optical fibers, which are then moved into contact forming a fusion bond. Due to the presence of a vacuum pump and complicated radio frequency power supplies and arc power supplies, this device is not usable in enclosed spaces and tight locations such as the interior spaces found in airlines, ships, or advanced machinery that frequently use optical communication.

U.S. Pat. No. 4,878,933 to Yamada, et al. discloses an apparatus for fusion splicing optical fibers. A light weight X Y translation device is positioned below a pair of V grooves holding two ends of optical fibers that are to be fused by electric arc discharge. A microscope and TV attachment is provided for viewing the ends of the optical fibers. Since the ends of the optical fibers are clearly in the ambient air, an arc formed is not isolated from ambient air that contains explosive gases or particles and therefore is likely to create an explosion.

U.S. Pat. No. 5,009,513 to Onodera, et al. discloses a method of measuring a quantity of heat applied to optical fiber. In this method of measuring a quantity of heat, the distance between the position of an end of an exposed fiber portion before heating and the position of the end after heating is measured, and the quantity of heat applied to the end of the exposed fiber portion is calculated based on the distance. When heat is applied to an end of an exposed fiber portion, the end is fused and rounded due to surface tension. For this reason, the position of the end of the exposed fiber portion retracts from the position it occupied before heating by the volume required for rounding the end. This retraction amount corresponds to a quantity of heat applied to the end of the exposed fiber portion. Therefore, by measuring the retraction amount, the quantity of heat applied to the ends of the exposed fiber portion can be quantitatively measured. The V blocks used to carry individual fibers of an optical fiber ribbon are moved to bring the heated softened fibers into contact creating a fusion bond. The fusion process is conducted in the ambient air. If the ambient air contains any explosive gases or particles, the arc will likely ignite the explosive gases or powders, creating an explosion.

U.S. Pat. No. 5,122,638 and its continuation, U.S. Pat. No. 5,228,102, to Sato, et al. discloses an optical fiber fusion splicer. This optical fiber fusion splicer includes a discharge unit for producing an electric discharge to fusion splice optical fibers and a pressure sensor for producing a pressure detection signal representing the surrounding atmospheric pressure. In response to the pressure detection signal, the discharge is controlled by a control unit so that a substantially optimum discharge current for the fusion splicing is provided to the discharge unit. The discharge control unit includes an adjusting unit for producing a discharge current adjusting signal, a control signal-generating unit for generating a control signal on the basis of both the pressure detection signal and the discharge current adjusting signal, and a discharge current control unit for controlling the discharge current in response to the control signal. The control unit for the optical fiber fusion splicer includes an atmospheric pressure sensor and the output of this sensor is used to lower the electrical arc discharge current as the atmospheric pressure increases to produce optimum optical fiber fusion splices. The optical fiber fusion process is conducted in the ambient air; it is incapable of preventing explosions if the ambient air contains explosive gases or powders.

U.S. Pat. No. 5,638,476 to Zheng discloses controlled splicing of optical fibers. Two optical fibers are spliced or connected by means of fusion welding in the principally conventional manner and then first the end surfaces of the fibers are placed opposite each other with the longitudinal directions of the fiber ends parallel to each other and very close to, engaging or almost engaging, each other. The end regions adjacent to the end surfaces are then heated, until the material in the fibers adjacent to the end surfaces is melted and the melt-fusioning of the ends of the two fibers has been achieved. This controlled splicing of fibers produces fiber joints that have a known optical attenuation. The fiber cores are displaced from each other laterally to produce this optical attenuation reliably. By means of the offset exterior surfaces and thus offset cores in a produced splice attenuation, elements can be produced having an attenuation of e.g. between 0.3 dB and 10 dB. The fusion of fibers is conducted using an electrical arc, which is in the ambient air. If the ambient air contains explosive gases or powders, the interaction between the electrical arc and the impure ambient gases will likely result in an explosion.

U.S. Pat. No. 5,909,527 to Zheng discloses automatic current selection for single fiber splicing. The intensity of light emitted from the fibers when optical fibers are heated by electric arc during fusion is measured for determining an optimal fusion current. These currents are selected to be significantly lower than the range, in which the optimal fusion current can be expected to be located. From the relation of the measured light intensity values and the different set currents a functional relationship is obtained, which is used for extrapolating to find the current which produces a higher light intensity value, which is the desired one during the actual welding. This is based on the assumption that the light intensity emitted from the fibers is dependent on the current used when heating the fibers in the electric arc between the welding electrodes. An exponential type relation can be used, requiring only two parameters to be measured for each splice and thus two different currents for heating the fiber in the arc is sufficient for determining the optimal fusion. Such a determination is easily implemented in automatic splicers having advanced image processing and logic and calculation facilities and gives good results for splices made e.g. at different heights above sea level. The intensity of light emitted by the ends of fiber that is heated by the arc current is used to control the fusion arc current to produce higher quality fused splices of optical fibers. The fusion process is not indicated to be conducted in an inert atmosphere that excludes ambient air that is contaminated with explosive gases or powders, and therefore is not an explosion proof optical fiber fusion process.

U.S. Pat. No. 6,799,903 to Sato, et al. discloses a fusion splicer and a fusion splicing method for optical fibers. This fusion splicer and fusion splicing method for optical fibers includes a TV camera which obtains transmitted light images passing respectively through side areas of two optical fibers. An image processing unit calculates mode field diameters of the respective optical fibers from brightness distributions of the images in terms of directions traverse to the optical fibers to calculate a diametric difference between the mode field diameters. A movable base moves abutted portions between the optical fibers relative to an electric discharge beam position. A drive unit implements additional electric discharge heating after applying electric discharge fusion splicing heating to the abutted portions while moving the electric discharge beam position toward one of the optical fibers, of which the mode field diameter is regarded to be small. A control unit controls an electric discharge power supply. The ends of the fiber that are heated by the electric arc are imaged as the fibers are brought together during fusion to determine when the fusion is complete. The shape of the brightness profile of the heated optical fibers in the arc is used to assess the fusing of optical fibers. This fusion method enables fusing of different core diameter or different mode fibers. The fusing operation is conducted in ambient air and the electrical arc is not protected by inert gases. Any explosive gas or powder contamination in the ambient air will cause an explosion and, therefore, this device is not an explosion proof optical fiber fuser.

U.S. Pat. No. 6,817,786 to Sato, et al. discloses a fusion splicing method and a device for optical fibers. In a fusion splicing method and device for optical fibers, bare fibers (f) of ribbon optical fibers “F”, appointed to be spliced together, are arranged in opposite direction to each other on a fiber setup stage. An interval of a pair of the discharge electrode rods is optionally changed according to the fiber number of the bare fibers “f” of the ribbon optical fiber “F” so that all of the bare fibers “f” are set into a uniform temperature area in a discharge area, and an optimum fusion splicing process is performed according to the fiber number of the bare fibers “f”. A plurality of fibers form a ribbon and two ribbons are mounted on a stage in V grooves. The ends of fibers are moved into close proximity. The electrodes perpendicular to the line of fibers are moved to a distance L to strike the arc and fuse the ends of the optical fibers. The fusing operation uses a plurality of optical fibers, not a single optical fiber. The fusing operation is conducted in ambient air and the electrical arc is not protected by inert gases. Any explosive gas or powder contamination in the ambient air may cause an explosion, and therefore this device is not an explosion proof optical fiber fuser.

U.S. Pat. No. 6,886,998 to Kasuu, et al. discloses a method for fusion splicing optical fibers and apparatus for heating a spliced part by arc. The arc is used to fuse two optical fiber ends placed facing each other with an arc having high intensity to soften or melt the fibers, at which point, the fibers are brought into contact. The arc intensity is progressively decreased by either passing argon gas or decreasing arc current. This progressive cooling prevents the bulging of the fused portion, which will increase optical losses at the fused joint of the optical fibers. Even though argon is used in the later part of the arc fusion process, it is not present during substantially the entire time that the arc is turned on. If the ambient air contains explosive gases or powders, the arc may ignite into an explosion. This device is not an explosion proof optical fiber fuser.

U.S. Pat. Nos. 7,317,171 and 7,342,198 to Wiley disclose a method and apparatus for generating an electric arc. This method and apparatus reduces the gap resistance between two electrodes, such as the electrodes used when fusion splicing one optical fiber to another, by injecting negative ions into the gas or gasses that are located between the electrodes. As a result, the voltage that is required to cause dielectric breakdown and initiation of the electrical arc is drastically reduced. The arc initial striking voltage is kept low by the injection of ionized gases from a separate gas source, even though the method of ionization of the gas source is not detailed since all gases supplied are not ionized and the electrodes of the arc with the impressed voltage cannot be expected to ionize the gas supplied. The optical fibers are first placed slightly outside the electrical arc to burn off the polymeric fiber coating and then inserted within the plasma arc to fuse the fibers. The use of ionized gases is indicated to improve the stability of the plasma arc. Even though an enclosure is used, the arc is not indicated to be strictly within the injected gas; but is, instead, present in predominantly ambient air. If the ambient air contains explosive gases or powders, the arc may ignite an explosion. This device is not a compact explosion proof optical fiber fuser capable of being used in confined locations.

U.S. Pat. No. 7,494,288 to Ozawa, et al. discloses an optical fiber fusion splicer and method for estimating a shape of beam discharged by the optical fiber fusion splicer. There is provided a fusion splicer for fusion splicing optical fibers with low splice loss even when a shape of a discharge beam for the splicing is distorted. A preliminary discharge is performed with the optical fibers outside a discharge area and an image of the discharge beam thereof is picked up. Based on this image, brightness distributions of the discharge beam are estimated on a plurality of lines in a Z direction that are set in different positions in an X direction, and a discharge center of the beam is found from the plurality of brightness distributions. Then, the abutment portion of the optical fibers is positioned at the discharge center, and a main discharge is performed so as to fusion splice the distal ends of the optical fibers. The arc is struck in the ambient air since there is disclosure of enclosure or supply of inert gas in the arc region. If the ambient air contains explosive gases or powders, the arc may ignite an explosion. This device is not a compact explosion proof optical fiber fuser and cannot be used in confined tight locations.

U.S. Published Patent Application No 20080217303 to Blagrave; James E. (hereinafter, “the '303 patent publication”) discloses an optical fiber fusion splice device for use in confined spaces. The optical fiber fusion splice device includes a receiving mechanism, internal chamber, alignment mechanism and circuitry, and an optical welding module. The receiving mechanism is operable to receive a pair of optical fibers that have been prepared for splicing. An internal chamber serves to isolate the optical fibers from an external environment. An alignment circuitry and mechanism aligns the first optical fiber to the second optical fiber within the internal chamber, wherein a welding module optically welds or fuses the aligned optical fibers. This welding module may employ an arc between a pair of electrodes, or other device such as an Edison coil, to heat and fuse the optical fibers. The internal chamber may be coupled to an evacuation system or positive displacement system in order to evacuate or pump volatile or contaminant-containing gases from the internal chamber prior to fusing the aligned optical fibers. The optical fibers to be fused are spaced within a cartridge that is evacuated or filled with inert gases and sealed. It appears that cartridge also has electrodes within it (shown by reference numeral 52) and has to be exactly at the correct position where the ends of the two optical fibers to be fused meet. The electrodes cannot be external to the cartridge since an arc cannot be struck through glass due to the high electrical resistance of glass. It is said that the cartridge may be inserted in tight aircraft locations without having to remove the harness, but this procedure is not possible since the cartridge has to be evacuated and sealed or filled with inert gas and sealed. Since the cartridge is sealed with inert gas or evacuated, there is no purging flow of inert gas. Due to the need for an external chamber, which receives the cartridge, the device would likely not be usable in enclosed locations.

U.S. Published Patent Application No 20130140290 to Kawasaki Hiroyuki, et al. discloses an optical fiber fusion splicer. The electrodes for producing the arc are clamped in electrode pressing members composed of aluminum selected for high thermal conductivity. The aluminum electrode pressing members are connected to heat dissipating fins. Passage of arc current repeatedly heats the electrodes, which are subject to oxidation. The aluminum electrode pressing member and fins cool the electrodes and prevent oxidation. The optical fiber fusing operation is obviously conducted in ambient air since the electrodes are indicated to oxidize. If the ambient air contains explosive gases or powders, the arc may ignite an explosion. This device is not a portable explosion proof optical fiber fuser.

Internet Publication Fusion Splicers at http://fujikura.fiberoptic.com/ discloses fusion splicers. Various models of commercial fiber fusing equipment produced by Fujikura are shown. Each of the fiber splicers uses arc fusion and an arc in ambient air. If the ambient air contains explosive gases or powders, the arc may ignite an explosion. None of these devices is a portable explosion proof optical fiber fuser.

Based on the foregoing, there exists a need for a compact optical fiber fusing system that reliably fuses optical fibers in an ambient that includes or is suspected to include explosive and hazardous gases or particles without causing explosions. Also needed in the art is a compact optical fiber fuser that is small enough to be usable in constrained locations such as inside the optical fiber signal processing equipment carried by airlines or marine vessels.

### SUMMARY OF THE INVENTION

The present invention provides an explosion proof fusion splicer system for splicing optical fibers with an arc contained within an enclosed space. Splicing is carried out in the presence of a purging inert gas. Ignition of ambient containing explosive gases is eliminated; splicing is effected efficiently in a highly reliable manner. The inert gas may be argon, helium, or nitrogen, which enables easy arc formation. An oxygen sensor monitors the purging action which is deemed adequate when oxygen content reaches adequate levels. A computer monitors the entire operation, recognizes when optical fibers are inserted within the fiber splicing equipment, turns on the inert gas supply, and monitors the inert gas flow and pressure. A video camera system monitors the tips of the optical fibers to assure that the ends of the fiber are properly cut and clean; and pushes the optical fibers together for contact. The maximum power level of the arc may be preselected by the user to prevent over heating or under heating of the optical fiber ends. Under heating or underfeeding of the ends of the optical fibers results in splice ends that are narrow; in turn resulting in physically weak splice ends in the optical fiber leading to optical intensity scattering and loss of optical signal.

Generally stated, the present invention provides a simple effective compact device that is capable of splicing optical fibers in an ambient atmosphere that may carry explosive or hazardous gases without the possibility of an explosion. Optical fibers are commonly used in high-speed data transmission, sensors of various types and other critical instruments; and are required to be spliced when the fiber is damaged. Typically the optical fibers have a protective polymeric sleeve, which may be removed prior to a splicing operation. Methods for removing the protective sleeve are well known in the art. Due to the computer control of the entire optical fiber fusing operation, reliable high quality optical fiber splices are obtained without danger of explosion even when explosive gases in the ambient atmosphere are suspected. Such situations arise in enclosed spaces, tight equipment enclosures, and the like where the equipment containing optical fibers cannot be generally serviced at the site, but may have to be removed to a laboratory. The system of the present invention provides a portable computer controlled optical splicing system that produces reliable high quality optical fiber splices at the site without possibility of explosions.

Significant advantages are realized by practice of the present invention. In its preferred embodiment, the explosion proof optical fiber splicer system of the present invention comprises:

i) a compact portable optical fiber fusing device for use in explosive containing ambient air;

ii) the optical fiber fusing device comprising an enclosed chamber with sealing gaskets fed with inert gas from a cylinder or tank or source, and having two arc forming electrodes mounted there within;

iii) the chamber having two apertures along a line perpendicular to the line of electrodes for the insertion and advancement of two optical fibers suited for arc fusing, said apertures being protected by close fitting seals retaining inert gas within the chamber;

iv) oxygen content of said chamber being purged by flow of inert gas and being detected by an oxygen sensor;

v) the optical fibers being moved to near close contact and the tips of the optical fibers being monitored by a video camera;

vi) the electrodes being energized to produce an electric arc only when adequate inert gas is present within the chamber, and said arc power being controlled to prevent overheating or underheating of said optical fiber tips; and

vii) the optical fibers being moved to touch their softened or molten tips together to create a fusion bond between the two optical fibers;

whereby ambient explosive gases are prevented from entry into the arc chamber by a control module, explosion is prevented, overheating or underheating of optical fibers is avoided, and transmission of optical signal through the fusion area is improved.

### BRIEF DESCRIPTION OF THE DRAWING

The invention will be more fully understood and further advantages will become apparent when reference is made to the following detailed description of the preferred embodiments of the invention and the accompanying drawing, in which:

FIG. 1 is a top plan view of an embodiment of the explosion proof fuser for optical fibers;

FIG. 2 illustrates a cross-sectional view of an embodiment of an optical fiber fusion chamber having an arc for fusing ends of two optical fibers;

FIG. 2a illustrates an expanded cross-sectional view of the arc of FIG. 2; and

FIG. 3 illustrates a top plan view showing the connectivity of the optical fiber fusion chamber with the control unit.

### DETAILED DESCRIPTION OF THE INVENTION

This invention relates to an explosion proof fusion splicing system for optical fibers. The system uses an arc contained within a closed space. A purging inert gas input prevents ignition of ambient that has explosive gases, thereby preventing explosion. The inert gas may be argon, helium, or nitrogen, which enables easy arc formation. A low cost carbon dioxide purging gas may be used. An oxygen sensor monitors the purging action which is deemed adequate when oxygen content reaches below 8%, preferably below 4%. A computer monitors the entire operation, recognizes when optical fibers are inserted within the fiber splicing equipment, turns on the inert gas supply, and monitors, within the inert gas, pressure in the arc forming region to make sure that the purging action is adequate, as indicated by the oxygen sensor, and the pressure within the chamber is greater than ambient pressure, and only then turns on the arc. A video camera system monitors the tips of the optical fibers to assure that they have been cleaved to defect-free flat ends perpendicular to the fibers' axis and that they are free of dirt or contamination; and pushes the optical fibers for contact. The maximum power level of the arc may be preselected by the user to prevent overheating or underheating of the optical fiber ends.

The Explosion-Proof Fusion Splicer combines a number of components and techniques into a unitary device to prevent it from ever posing a hazard in flammable or explosive atmospheres. The fundamental approach may be called exclusion, that is, the use of a purging gas to displace the ambient air within the splicer chamber. Ambient air presumed to have flammable or explosive constituents is displaced with an alternate gas mixture that is not flammable. Such an alternate gas mixture may comprise argon, nitrogen, helium, or carbon dioxide.

A number of components and methods are used in varying combinations (usually not all of them at once) to achieve this end:
Inert gas is provided from a source, which may be a tank or bottle. In the prototypes it was pure nitrogen supplied either from small canisters or from a 20 pound or 100 pound tank. Alternative inert gases include argon, helium, carbon dioxide, or others. Nitrogen, argon, and helium support an arc well while carbon dioxide is less effective in supporting an arc. As an alternative to a tank or reservoir, the inert gas could be generated on-site, as by dissolving a mixture of sodium bicarbonate and citric acid in water to produce carbon dioxide.
Regulator to insure that the purging gas is delivered into the equipment at a suitable pressure.
Automatic valve to allow purging gas flow when it is needed and to prevent the purging gas flow and conserve the gas supply otherwise.
Tubing, channels, conduits, or the like to conduct the purging gas where it is needed.
Flow sensor(s) in the controller to measure the volume of purging gas delivered and optionally the volume of gas exhausted.
Oxygen sensor(s) to measure the concentration of the gas within the splicer chamber and optionally at the exhaust of the splicer chamber as well. (Optional: gas species sensors for the purging gas and/or hydrocarbons.)
Pressure sensor to insure that the tank or reservoir contains sufficient purging gas for at least one splicing cycle.
Pressure sensor to insure from slight overpressure that purging gas is being forced into the splicer.
Compliant cable seals on the fusion splicer to allow the fiber cables being spliced to be routed into the splicer through slots and yet suppress leakage of purging gas.
Cover seals on the fusion splicer such that the cover is easy to open and close, yet minimizing leakage of gas during purging and splicing.
Sealed enclosure: the fusion splicer is well-sealed everywhere except where openings are unavoidable (the cover and the cable slots).
Cover closure switch to indicate when the cover is fully closed.
Flow restriction in the exhaust line or tube to insure that the purging gas experiences a back pressure which the pressure sensor in the splicer chamber can measure.
Internal encapsulation of inert material to fill much or most of the empty space inside the fusion splicer to minimize the amount of purging gas required to displace ambient gas.
Circuit continuity sensor in the control cable, to determine whether the cable is properly connected.
Grounding in the control cable to insure that the fusion splicer, the cable, and the controller are all grounded in common so that no static potential can develop on any one component.

This compact and portable optical fiber fusing system provides the following advantages:
A fusion splicer, which can be proven explosion-proof by MIL-spec testing.
A miniature modular explosion-proof fusion splicer.
The use of sensors for oxygen and optionally other gases to confirm proper purging.
The combination of gas sensors with flow measurement to combine two techniques of insuring proper purging: having three times volume displacement, and confirmation that the oxygen content is below MOC (minimum oxygen content needed for combustion of explosive ambient).
A multiply-redundant system of actions and measurements for a high level of confidence that the system is explosion-proof.
An extremely small and light weight fusion splicer, which is also explosion-proof.
A miniature modular explosion-proof fusion splicer, which is also rugged and qualified to Class II of MIL-PRF-28800F.

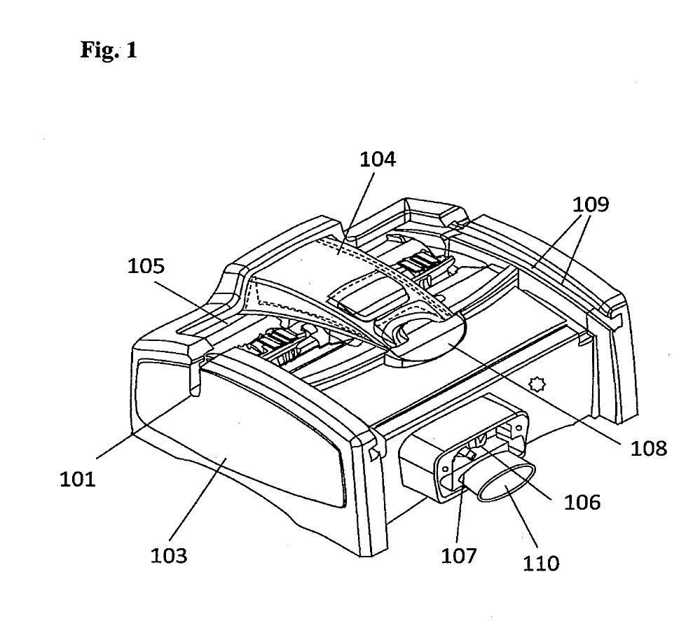

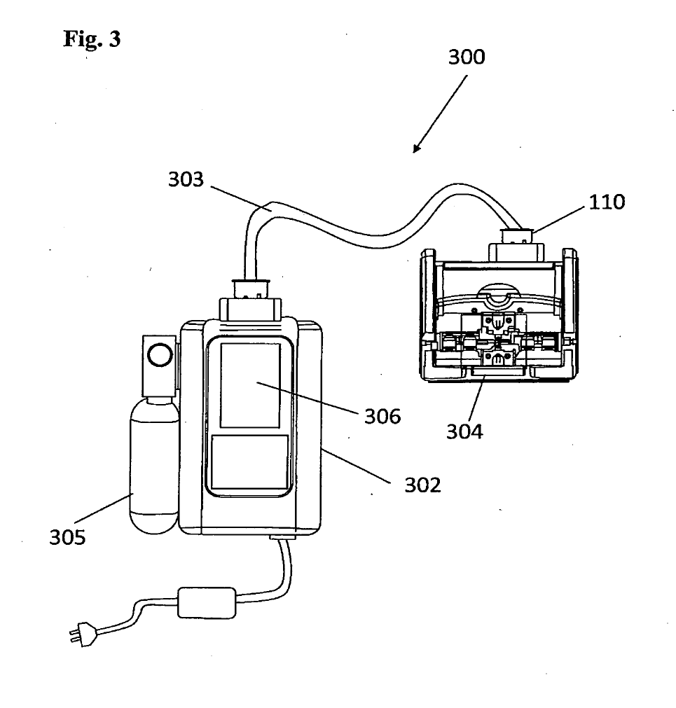

FIG. 1 shows at 100 a top plan view of an embodiment of the portable explosion proof splicer for optical fibers. When the cover release button 108 is pressed, the top portion of the device can be opened revealing a rectangular arc fusion chamber of the device. The fiber is first stripped of the polymeric cladding, cleaned, and cleaved with a precision cleaver to produce two ends of the optical fiber which are then placed on a platform; and the fibers are clamped using fiber clamps. The fiber extends outwards through aperture 101 (only one on the right side of the device is shown in the rendering). At this point, the top portion of the device is closed and the seals provided securely seal the fibers against the aperture at 101. An elastomeric jackeet 103, covers much of the device for protection from shocks or inadvertent drops. Foam seals 109 also engage, preventing leakage between top and bottom portion of the arc chamber. The sliding cover 105 is closed. This closure operation creates a nearly sealed arc chamber for fusing optical fibers without the possibility of ambient air containing explosive or hazardous constituents entering the arc chamber. (The fiber tips may be observed on a monitor as illustrated and discussed hereinafter pertaining to FIG. 3.) A video camera shield is shown at 104 which prevents ambient lighting from entering the fusion area and interfering with the camera's formation of usable images of the fibers. Next, inert gas from a supply is allowed into the chamber through port 106. One or more sensors are present in the arc chamber measuring inert gas pressure, inert gas flow volume, and oxygen content. The supply of electrical power, electrical sensor connections, and gas lines are connected through sealed port 110; these connect the photographed device to a control module as shown in FIG. 3 below.

The supply of inert gas purges the ambient gases out of the arc chamber, and the arc is struck only when adequate inert gas is present within the arc chamber. The inert gas is replenished as needed by purging, and the interior of the arc chamber is slightly above atmospheric pressure, thereby preventing the entry of atmospheric gases into the arc chamber. The entire operation is monitored by a control module. When the optical fiber fusion is complete, the control module turns off the inert gas supply and the fused fiber may be removed by pressing closure button 108 and sliding open the cover of the device. In this manner, the compact device may be used in a constricted location such as an instrument panel enclosure without the need for removing and disassembling various optical components.

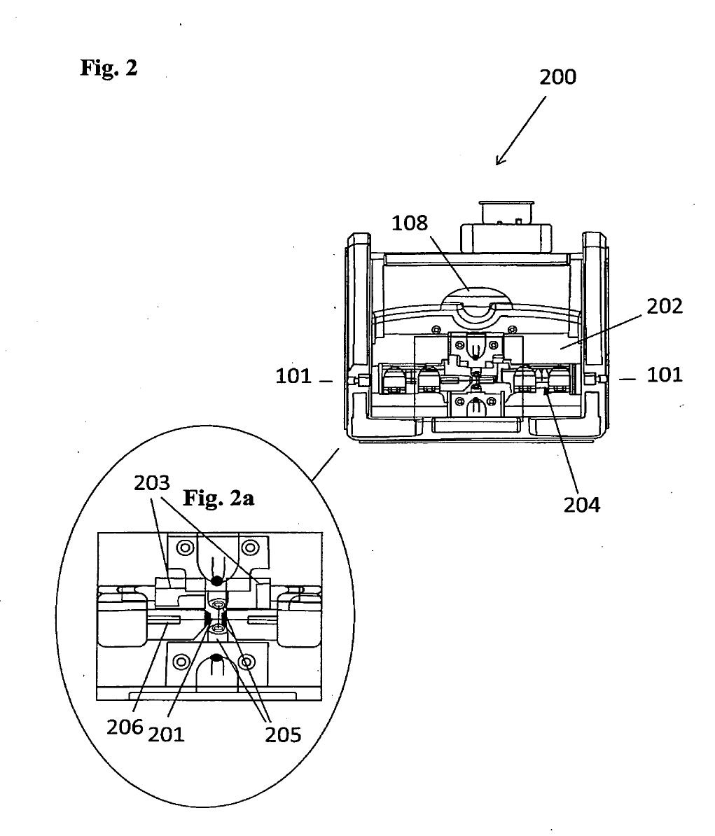

FIG. 2 illustrates a cross-sectional view of an embodiment of the optical details concerning an optical fiber fusion chamber that has an arc for fusing ends of two optical fibers. The closure button 108 and the two fiber entry or exit locations 101 are shown. The expanded cross-sectional view of the arc fusing region is shown in FIG. 2a. The bare end of the fiber is shown at 201. The fiber clamps are shown at 203. The electrodes that fire the arc are shown at 205. The fibers rest on fiber guides 206.

FIG. 3 illustrates a top plan view of the connection of the optical fiber fusion device with the control unit. The control unit or module 302 is powered by connection to an AC outlet. Incoming voltage is converted to 12 volts DC, providing compatibility with microprocessors present in the control module. The control module is connected to an inert gas supply, shown here as a gas cylinder 305. Power for arc current supply and communication of sensor information is supplied through the cable 303, which enters the sealed port 110. The arc fusion chamber is shown at 304 (details of the fusion chamber are shown in FIG. 2 and discussed hereinabove). Display images of the fibers and instructional and diagnostic messages are presented on the LCD monitor 306.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An explosion proof optical fiber fusing system, comprising:
a) an enclosed chamber having sealing gaskets fed with an inert gas supply and having two arc forming electrodes mounted therewithin and a device for opening and closing the top portion of the chamber;
b) the chamber having two apertures along a line perpendicular to the line of electrodes for the insertion and advancement of two optical fibers or cables suited for arc fusing;
c) said apertures being protected by close fitting seals retaining inert gas within the chamber and minimizing leakage of purging inert gas therefrom to thereby exclude entry of ambient explosive gases to said chamber;
d) the chamber oxygen content being purged by flow of inert gas and adequate absence of oxygen being detected by an oxygen sensor,
e) the optical fibers being moved to near close contact and tips of the optical fibers being monitored by at least one video camera;
f) the electrodes being energized only when the gas present within said chamber is purged below minimum oxygen content (MOC) to produce an electric; and
g) the optical fibers being moved to touch softened or molten tips of each fiber to create a fusion bond between the two optical fibers;
whereby ambient explosive gases are excluded from entry into the arc chamber by said control module, thereby preventing explosion.

2. The explosion proof optical fiber fusing system as recited by claim 1, wherein the inert gas is selected from nitrogen, argon, helium, and carbon dioxide.

3. The explosion proof optical fiber fusing system as recited by claim 2, wherein said inert gas supply of carbon dioxide is also provided with arc sustaining gases of nitrogen, argon, or helium.

4. The explosion proof optical fiber fusing system as recited by claim 1, wherein said inert gas supply is a cylinder, tank, or reservoir.

5. The explosion proof optical fiber fusing system as recited by claim 1, wherein said inert gas supply is a gas supply line.

6. The explosion proof optical fiber fusing system as recited by claim 1, wherein said inert gas purge adequateness is indicated by an oxygen content of less than 8%.

7. The explosion proof optical fiber fusing system as recited by claim 1, wherein said inert gas purge adequateness is indicated by an oxygen content of less than 4%.
